(19) United States
(12) Patent Application Publication
(10) Pub. No.: US 2014/0019167 A1
(43) Pub. Date: Jan. 16, 2014

(54) Method and Apparatus for Determining Insurance Risk Based on Monitoring Driver's Eyes and Head

(71) Applicants: Shuli Cheng, Las Vegas, NV (US); Michael Eissey Ciklin, Las Vegas, NV (US)

(72) Inventors: Shuli Cheng, Las Vegas, NV (US); Michael Eissey Ciklin, Las Vegas, NV (US)

(21) Appl. No.: 13/831,282

(22) Filed: Mar. 14, 2013

Related U.S. Application Data
(60) Provisional application No. 61/672,264, filed on Jul. 16, 2012.

(51) Int. Cl. G06Q 40/08

(52) U.S. Cl. CPC G06Q 40/08
USPC 705/4

(57) ABSTRACT

An insurance risk rating system and method are provided. The insurance risk rating system includes a driver sensor that obtains driver behavior data by monitoring at least one of the driver's head and one or more of the driver's eyes, a processing unit that compares the driver behavior data with reference data that relates the driver behavior data to loss data, and a risk rating unit that assigns a risk rating to the driver based on a result of the comparison by the processing unit.

### CROSS-REFERENCE TO RELATED APPLICATION

This application claims priority from U.S. Provisional Patent Application No. 61/672,264 filed on Jul. 16, 2012, the disclosure of which is incorporated herein by reference in its entirety.

### BACKGROUND

Methods and apparatuses consistent with the exemplary embodiments relate to determining risk and calculating an insurance premium based on a driver's awareness. More particularly, the exemplary embodiments relate to determining the risk associated with a driver and calculating an insurance premium by monitoring the driver's eyes.

### SUMMARY

Technological advances over the last decade have provided a growing number of potential distractions for drivers. Mobile phones, tablets, and other personal electronic devices make it possible for drivers to engage in a wide array of dangerous behaviors such as texting, sending email, updating social media profiles, etc.

More importantly, it is difficult to regulate these dangerous behaviors because they are difficult to detect. Some insurance companies have attempted to base premiums on a vehicle's measured usage involving metrics such as miles traveled, speed, location, and time of day of use. The method of assigning risk based on usage fails to take into account a more significant basis for vehicular loss, risk from the driver's lack of visual awareness, such as when driving while texting.

Accordingly, an aspect of one or more exemplary embodiments provides a method of monitoring the driver's awareness level in order to assess driver risk. The driver's awareness level is determined by analyzing the driver's eyes and head to collect gaze information or driver behavior data, which is used to calculate an insurance premium.

A method according to one or more exemplary embodiments may include monitoring the driver's eyes and head to obtain gaze information or driver behavior data, analyzing the gaze information or driver behavior data to determine the driver's awareness level by comparing the driver behavior data with reference data, and assigning an insurance risk rating and/or premium based on a result of the comparison. The method may also comprise generating a driver awareness profile for the driver based on the obtained driver behavior data.

The step of monitoring the driver's eyes and head to obtain gaze information or driver behavior data may include using a video camera or other monitoring device to record the driver's eye position, gaze coordinates, head orientation, viewing location, pupil diameter, eyelid opening and closing, blinking, and saccades.

The step of analyzing the gaze information may include, for example, determining the driver's gaze location, the duration that one or both of the driver's eyes fixates at each location, frequency of eye movement, patterns of moving the eyes between different locations, and head orientation. This step may also include correlating gaze data with vehicle data. For example, gaze data such as gaze location may be correlated with vehicle information such as vehicle speed, acceleration, deceleration, or steering wheel orientation to ascertain the driver's viewing location at particular speeds, during sudden starts or stops, or during sudden steering corrections. This step may ignore gaze locations while the vehicle is stopped or moving in a specific direction or at a speed below a predetermined threshold.

The analyzing step may include comparing the driver behavior data to reference data that comprises one or more distributions, each of which relates a driver behavior to historic and/or estimated loss data. The historic loss data may include the number of incident claims reported and/or estimated unreported claims associated with a driver behavior. If historic loss data is not available, an estimated number of incident claims associated with the driver behavior may be used.

The driver awareness data may include one or more of the driver's head orientation, head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure.

The step of constructing a driver awareness profile may include compiling statistics regarding the amount and/or percentage of time the driver's eyes and/or head are oriented at predetermined safe positions and/or predetermined dangerous positions. This step may also include identifying gaze location patterns and/or head orientations that correlate to particular high-risk behavior, such as sending or receiving text messages, manipulating the vehicle's radio, audio system, or global positioning system (GPS), or driving under the influence of drugs or alcohol. The driver awareness profile may also include the number of times the driver makes sudden stops or sudden direction corrections while or immediately following the driver's eyes or head being oriented at a dangerous gaze locations.

The step of assigning an insurance risk rating and premium may include comparing the driver's awareness profile to a predetermined standard or aggregate profile of numerous drivers. For example, all driver awareness profiles may be combined into an aggregate model to determine which viewing locations and/or head orientations are most commonly associated with accidents or high-risk driving, such as sudden stops or direction changes. Safe and dangerous gaze locations may be determined based on the aggregate model. Aggregate models may be further subdivided by age group, vehicle type, geographic location, or other parameters. A driver's awareness profile may be compared to one or more aggregate models to assign the insurance risk and premium based on the profile's similarity or dissimilarity from the aggregate model(s). The driver awareness profile may also be compared to other driver awareness profiles, and insurance risk and premium assigned based on the profile's relative standing as compared to other profiles.

The insurance risk rating may be adjusted based on the actuarial class of the driver.

The method may also include a step of communicating the driver's insurance risk and/or premium adjustment to the driver. For example, the driver's insurance risk rating and premium adjustment may be communicated to the driver via the vehicle's audio system, on a display device within the vehicle when the vehicle is not moving, or via a web or mobile application, etc.

According to another aspect of one or more exemplary embodiments, there is provided a system for monitoring a driver's eyes to obtain gaze information or driver behavior data, which is used to calculate an insurance premium.

A system for calculating insurance premiums based on driver awareness according to one or more exemplary embodiments may include one or more on-board monitors, such as an image capturing device, that captures gaze information or driver behavior data by monitoring a driver's eyes and/or head; an information processing device, such as a processing unit and memory, which processes gaze information or driver behavior data to generate driver awareness profiles and compare the driver behavior data with reference data that relates the driver behavior data to loss data; one or more remote servers that are able to communicate with the information processing device via a communication network, and store and process one or more of gaze information, driver awareness profiles, and aggregate driver profiles; and a client server that communicates driver risk information and premium information to the driver.

The on-board monitors may include driver sensors, such as a video camera, that captures the driver's gaze information, such as eye position, gaze coordinates, head orientation, viewing location, pupil diameter, eyelid opening and closing, blinking, and saccades. The monitors may also include one or more vehicle sensors that monitor the vehicle speed, acceleration and/or deceleration, and vehicle steering data.

The information processing device may include a processing unit and a memory unit. The information processing device may receive driver behavior data and vehicle information from the on-board monitors and process the information to determine the driver's viewing location, the duration the driver's eyes are oriented at each gaze location, frequency of eye movement, patterns of moving the eyes between different viewing locations, and head orientation. The information processing device may also correlate gaze information with vehicle data. For example, gaze information such as gaze location may be correlated with vehicle information such as vehicle speed, acceleration, deceleration, or steering wheel orientation to ascertain the driver's viewing location at particular speeds, sudden starts or stops, or sudden steering corrections. The information processing device may ignore viewing locations while the vehicle is stopped or moving at a speed below a predetermined threshold.

The information processing device may create a driver awareness profile by compiling statistics regarding the amount and/or percentage of time the driver's eyes and/or head are oriented at predetermined safe locations and/or predetermined dangerous locations. The information processing device may also identify gaze location patterns that correlate to particular high-risk behavior, such as sending or receiving text messages, manipulating the vehicle's radio, audio system, or global positioning system (GPS), or driving while sleep-deprived or under the influence of drugs or alcohol. The driver awareness profile may also include the number of times the driver makes sudden stops or sudden direction corrections while or immediately following the driver's eyes being oriented at a dangerous gaze location.

The processing unit may compare the driver behavior data to reference data that comprises one or more distributions, each of which relates a driver behavior to historic and/or estimated loss data. The historic loss data may include the number of incident claims reported and/or estimated unreported claims associated with a driver behavior. If historic loss data is not available, an estimated number of incident claims associated with the driver behavior may be used.

The driver awareness data may include one or more of the driver's head orientation, head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure.

The remote servers may include analytics servers and data storage, such as a database. The remote servers may receive the processed gaze information, vehicle information, or driver awareness profile. Alternatively, the remote servers may receive processed gaze information and vehicle information, and generate the driver awareness profile based on the received gaze and vehicle information.

The analytics servers may assign an insurance risk rating and premium by comparing the driver's awareness profile to a predetermined standard or aggregate profile of numerous drivers, which may be stored in the database. For example, all driver profiles may be combined into an aggregate model to determine which viewing locations are most commonly associated with accidents or high-risk driving, such as sudden stops or direction changes. Safe and dangerous viewing locations may be determined based on the aggregate model. Aggregate models may be further subdivided by age group, vehicle type, geographic location, or other parameters to create additional models that may be stored in the database. A driver's awareness profile may be compared to one or more aggregate models to assign the insurance risk and premium based on the profile's similarity or dissimilarity from the aggregate model(s). The driver awareness profile may also be compared to other driver awareness profiles, and insurance risk and premium assigned based on the profile's relative standing as compared to other profiles.

The insurance risk rating may be adjusted based on the actuarial class of the driver.

The client server may include a web server and an application server. The client server may receive insurance risk rating and premium information from the remote servers, and may provide this information to the driver via a web interface, text message, cell phone application, etc., for example, when the driver has completed his or her trip. The insurance risk rating and premium information may be provided to the user via a display device in the vehicle or through the vehicle's audio system. The client server may also receive driver awareness profile and/or gaze information, and communicate this information to the driver.

By monitoring the driver's eyes and head, insurance carriers are able to more accurately assess the risk associated with a particular driver based on the particular driver's awareness level. Insurance carriers are then able to adjust a driver's insurance premium based on the driver's awareness, which provides incentive for the driver to avoid dangerous driving behaviors such as texting.

### BRIEF DESCRIPTION OF THE DRAWINGS

FIG. 1 shows a block diagram of an insurance premium calculation system based on a driver's awareness according to an exemplary embodiment.

FIG. 2 is a flowchart showing an insurance premium calculation method based on driver awareness according to an exemplary embodiment.

FIG. 3 is a logic diagram illustrating an insurance premium calculation method based on observed driver behavior according to an exemplary embodiment.

FIG. 4 is an expanded view of the Logic Process block shown in FIG. 3.

FIG. 5 is a representation of a driver's field of vision while operating a vehicle according to an exemplary embodiment.

FIG. 6 shows a driver report card according to an exemplary embodiment that indicates the number of observed risky driver behaviors.

FIG. 7 shows a reference distribution curve (D-curve) for a particular driver behavior according to an exemplary embodiment.

FIGS. 8A-8D show sample D-curves for a particular driver behavior while the vehicle is traveling at various speeds, according to an exemplary embodiment.

### DETAILED DESCRIPTION OF EXEMPLARY EMBODIMENTS

Reference will now be made in detail to the following exemplary embodiments, which are illustrated in the accompanying drawings, wherein like reference numerals refer to the like elements throughout.

The exemplary embodiments may be embodied in various forms without being limited to the exemplary embodiments set forth herein. Descriptions of well-known parts are omitted for clarity, and like reference numerals refer to like elements throughout.

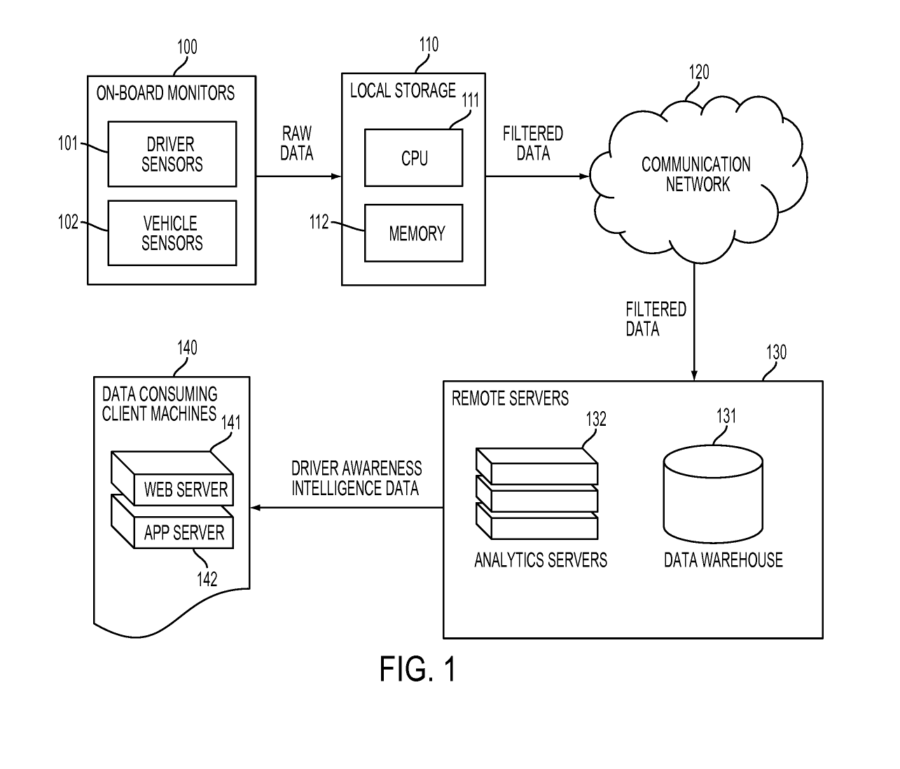

FIG. 1 is a block diagram of an insurance premium calculation system according to an exemplary embodiment. Referring to FIG. 1, an insurance premium calculation system according to an exemplary embodiment may include on-board monitors 100, local storage 110, communication network 120, remote servers 130, and client servers 140. The on-board monitors 100 may include driver sensors 101 and vehicle sensors 102, as well as a display device (not shown).

The driver sensors 101 monitor the driver's eyes and/or head to capture gaze information or driver behavior data such as gaze location, duration that eyelids are open, frequency of eye movement, patterns of moving the eyes between different gaze coordinates, eye position, head orientation, pupil diameter, eyelid opening and closing, blinking, and saccades. For example, the driver sensors 101 may plot the driver's gaze location on a vertical plane that is substantially perpendicular to the road, in order to determine an estimation. Many different types of driver sensors may be used, such as, without limitation, video cameras, infrared cameras, a mounted mobile device, glasses enabled with video/image capturing capability, or any other type of video/image capturing device. In addition, driver sensors 101 may include sensor devices disclosed by U.S. Pat. No. 6,154,599, U.S. Pat. No. 6,496,117, and U.S. Pat. No. 5,218,387, the disclosures of which are incorporated herein by reference in their entirety. Driver sensors 101 may also include facial recognition capabilities that distinguish between different drivers that may be operating the vehicle.

Vehicle sensors 102 may monitor various vehicle parameters to collect vehicle information. These parameters may include, without limitation, vehicle velocity, acceleration, and deceleration, as well as steering wheel orientation, vehicle location, direction of travel, time of travel, and airbag deployments.

Local storage 110 may include a central processing unit (CPU) 111 and memory 112. Local storage 110 receives gaze information and vehicle information from on-board monitors 100, and stores the gaze information and vehicle information in memory 112. The CPU 111, may process the gaze information received from the driver sensors 101 to determine the driver's viewing location, the duration the driver's eyes are oriented at each viewing location, frequency of eye movement, and patterns of moving the eyes between different viewing locations. The CPU 111 may also correlate gaze information with vehicle information received from vehicle sensors 102. For example, gaze data such as gaze location and head orientation may be correlated with vehicle information such as vehicle speed, acceleration, deceleration, or steering wheel orientation to ascertain the driver's viewing location at particular speeds, or just prior to sudden stops or steering corrections.

The CPU 111 may also generate a driver awareness profile based on the gaze information and/or vehicle information received from the on-board monitors 100. In order to generate the driver awareness profile, the CPU 111 may compile statistics regarding the amount and/or percentage of time the driver's eyes are oriented at predetermined safe locations and/or predetermined dangerous locations. This process may also include identifying gaze location patterns or head orientation patterns that correlate to particular high-risk behavior, such as sending or receiving text messages, manipulating the vehicle's radio, audio system, or global positioning system (GPS), or driving under the influence of drugs or alcohol. The driver awareness profile may also include the number of times the driver makes sudden stops or sudden direction corrections while or immediately following the driver's eyes being oriented at a dangerous viewing location. In creating the driver awareness profile, the CPU may disregard detected dangerous viewing locations or head orientations while the vehicle is stopped or moving at a speed below a predetermined threshold. The driver awareness profile is then stored in memory 112.

According to an exemplary embodiment, CPU 111 may generate the driver awareness profile by comparing obtained gaze information or driver behavior data with reference data that relates the gaze information or driver behavior data to loss data. As discussed further below, the reference data may relate a particular behavior to historic and/or estimated loss data that is associated with the particular behavior. For example, the reference data may be in the form of a distribution curve that relates, for instance, the number of times the driver looked down within a one minute period to a number of insurance claims filed. The number of insurance claims filed may be the actual number of claims filed for accidents associated with a driver looking down, an estimated number of claims, or a combination thereof. The loss data may also include, without limitation, the number of vehicle impacts, swerves, steering overcorrections, and/or hard brakes. If the actual loss data, such as the number of insurance claims reported, is not available for a particular behavior, loss data for a particular behavior may be estimated by various methods that are known by those of ordinary skill in the art.

The reference data may also relate multiple driver behaviors to historic and/or estimated loss data that is associated with the particular behaviors. For example, the reference data may represent a relationship between loss data and a particular driver behavior that occurs while the vehicle is moving at a particular speed. The reference data may associate loss data with any type of driver behavior. For example, the driver behavior may include, without limitation, the driver's head orientation, head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure.

CPU 111 may include, but is not limited to, a software or hardware component, such as a Field Programmable Gate Array (FPGA) or an Application Specific Integrated Circuit (ASIC), which performs certain tasks, and may include multiple processors. CPU 111 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components may be combined into fewer components or further separated into additional components.

Memory 112 may include any type of storage device, such as volatile or nonvolatile memory devices including, without limitation, dynamic random access memory (DRAM) and static RAM (SRAM), programmable read only memory (PROM), erasable PROM (EPROM), electrically erasable PROM (EEPROM), flash memory, ferroelectric RAM (FRAM) using a ferroelectric capacitor, magnetic RAM (MRAM) using a Tunneling magneto-resistive (TMR) film, and phase change RAM (PRAM).

The CPU 111 may also generate different driver awareness profiles for each driver that operates the vehicle, based on facial recognition results provided by driver sensors 101. In particular, the driver sensors 101 may perform a facial recognition process to determine who is driving the vehicle, and provide this information to CPU 111. The CPU 111 may then determine if the facial recognition results match any of the driver awareness profiles stored in memory 112. If there is a match, the corresponding driver profile may be updated based on the processed gaze information and vehicle information. If the facial recognition results do not match any of the driver awareness profiles, the CPU creates a new driver awareness profile that is associated with the facial recognition results.

Alternatively, memory 112 may store only one driver awareness profile for the vehicle. The CPU 111 may then update the profile based on processed gaze information and vehicle information, regardless of who is driving the vehicle. In this way, the driver awareness profile is able to monitor the awareness of all drivers of the vehicle.

The CPU 111 may cause the driver awareness profile(s) and/or the processed gaze information and vehicle information to be transmitted to remote servers 130 via communication network 120. Remote servers 130 may include data warehouse 131 and analytics servers 132.

The driver awareness profile(s) and/or the processed gaze information and vehicle information may be stored in data warehouse 131. Alternatively, only the processed gaze information and vehicle information may be transmitted to the remote servers 130, and analytics servers 132 may generate the driver awareness profile(s) based on the processed data.

The analytics servers 132, or risk rating unit, may assign an insurance risk and premium based on the driver awareness profile and/or the processed gaze information. The analytics servers 132 may combine driver awareness profiles from numerous different drivers and different vehicles into an aggregate profile that is stored in data warehouse 131. For example, viewing locations and/or head orientations from different drivers may be combined to determine an average percentage of time during which a driver's eyes and/or head are at dangerous and safe viewing locations, or determine which viewing locations and/or head orientations are most commonly associated with accidents or high-risk driving, such as sudden stops or direction changes. Safe and dangerous viewing locations may be determined based on the aggregate model. Aggregate models may be further subdivided by age group, vehicle type, geographic location, or other parameters, and are also stored in data warehouse 131.

Additionally, driver awareness profiles may include categories of dangerous activities that are associated with certain gaze information. For example, when the driver repeatedly looks down and then back at the road at some predetermined interval, the CPU 111 or analytics servers 132 may determine that such gaze information indicates that the driver is texting. Data warehouse 131 may compile and store statistics regarding these detected dangerous activities, such as how many drivers are engaging in these activities, how often they occur, among which demographics the activities occur, how many accidents (as detected by, for example, airbag deployments) are temporally associated with these activities, and which geographic regions contain the highest concentrations of these activities.

Analytics servers 132 may compare a driver's awareness profile to one or more aggregate models stored in data warehouse 131 to assign the insurance risk and premium based on the profile's similarity or dissimilarity from the aggregate model(s). The analytics servers 132 may also compare the driver awareness profile to other individual driver awareness profiles stored in data warehouse 131, and assign an insurance risk and premium based on the profile's relative standing as compared to other profiles.

According to an exemplary embodiment, the analytics servers 132 may also determine an insurance risk by aggregating the loss data corresponding to a plurality of observed driver behaviors. For example, if a driver's eyes are observed to be oriented at an unsafe location three times in one minute, and are observed to be closed for more than one second two times in a single minute, the loss data associated with each of these behaviors may be combined in order to determine an overall insurance risk. Combining loss data for different behaviors may include adding the number of insurance claims that correspond to each observed driver behavior, assigning weights to each set of loss data depending on the relative risk associated with the corresponding observed driver behavior, or any other method of aggregating loss data for different driver behaviors. For example, if it is determined that a driver's eyes being closed for more than one second creates a greater risk of accident than the driver's eyes being oriented at an unsafe location, the loss data associated with the driver's eyes being closed for more than one second may be given greater relative weight when combining loss data to determine an insurance risk.

The insurance risk rating may also be adjusted based on the actuarial class of the driver. For example, the insurance risk may adjusted based on one or more of, without limitation, the driver's age, vehicle type, vehicle age, and whether the driver wears glasses or contact lenses.

Once the insurance risk is determined, an insurance premium may be determined based on the determined insurance risk. For example, data warehouse 131 may include a database, lookup table, etc. that maps insurance risk to the insurance premium charged to the driver, however the database is not required to be stored in data warehouse 131 and may be stored in local storage 110 or elsewhere.

With further reference to FIG. 1, client servers 140 may include a web server 141 and an application server 142. Client servers 140 may receive the determined insurance risk, premium, driver awareness profile, and/or processed gaze information associated with a particular driver from remote servers 130. The web server 141 may allow the user to access this information through the user's web browser by providing the information via the Internet. For example, the web server may allow the driver to access this information from the insurance carrier's website, or include this information in an email message sent to the driver's email address. The driver or policyholder may also provide additional email addresses, such as that of a parent who wants to monitor their teenager's awareness, so that the information may be provided to multiple individuals. Application server 142 may interact with a user's cell phone or tablet applications in order to provide insurance risk, premium, driver awareness profile, and/or the gaze information.

Alternatively, CPU 111 may provide processed gaze information and vehicle information to a display apparatus in the vehicle to inform the driver of his or her awareness. For example, the CPU 111 may calculate the percentage of time the driver's eyes or head were pointed at a predetermined safe direction, and relay this information to the driver via a display apparatus and/or through the vehicle's audio system. According to an exemplary embodiment, if the gaze information or driver behavior data is processed by analytics servers 132, the processed information is transmitted back to local storage 110 via communication network 120 to be relayed to the driver via a display apparatus and/or through the vehicle's audio system.

By providing the awareness information to the driver, the driver is able to adjust his or her driving habits in order to reduce the charged premium, thus incentivizing safer driving habits.

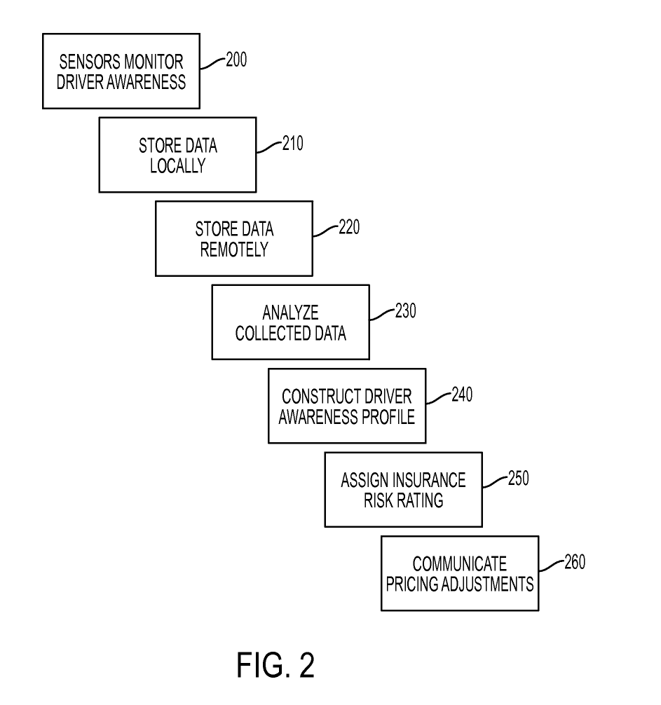

FIG. 2 is a flowchart of an insurance premium calculation method according to an exemplary embodiment. Referring to FIG. 2, driver sensors installed in the vehicle monitor the driver's awareness by observing the driver's eye movement and head orientation in step 200. By monitoring the driver's eyes, the driver sensors are able to obtain gaze information or driver behavior data, such as the driver's viewing location, the extent to which the driver's eyes are open, eye position, gaze coordinates, head orientation, pupil diameter, eyelid opening and closing, blinking, and saccades. The gaze information or driver behavior data may also include head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure. Monitoring step 200 may be performed by many different sensing devices, such as video cameras, infrared cameras, etc., as discussed above. Step 200 may also include monitoring vehicle data, such as vehicle velocity, acceleration, and deceleration, as well as steering wheel orientation, vehicle location, direction of travel, time of travel, and airbag deployments.

In step 210, the obtained gaze information is stored locally in a memory. As described above, the memory may be any type of memory storage device including volatile and non-volatile memory devices.

In step 220, the obtained gaze information or driver behavior data may also be stored in a remote server, such as remote servers 130 in FIG. 1.

In step 230, the gaze information and vehicle information are processed. This step may be performed by a processor, such as CPU 111, by determining the driver's gaze location, the duration the driver's eyes are oriented at each coordinate, frequency of eye movement, patterns of moving the eyes between different viewing locations, eye position, gaze coordinates, head orientation, pupil diameter, eyelid opening and closing, blinking, and saccades. This step may also include correlating gaze information with vehicle information received from vehicle sensors 102. For example, gaze information such as viewing location and/or head orientation may be correlated with vehicle information such as vehicle speed, acceleration, deceleration, steering wheel orientation, or airbag deployment to ascertain the driver's viewing location and/or head orientation at particular speeds, or just prior to sudden stops or steering corrections, or accidents resulting in airbag deployment.

In step 240, the processed data is used to construct a driver awareness profile. This step may be performed by, for example, CPU 111 or analytics servers 132 in FIG. 1. The step of generating the driver awareness profile may include compiling statistics regarding the amount and/or percentage of time the driver's eyes are oriented at predetermined safe gaze locations and/or predetermined dangerous gaze locations. This process may also include identifying viewing location patterns and head orientations that correlate to particular high-risk behavior, such as sending or receiving text messages, manipulating the vehicle's radio, audio system, or global positioning system (GPS), or driving under the influence of drugs or alcohol. The driver awareness profile may also include the number of times the driver makes sudden stops or sudden direction corrections, or is involved in an accident, while or immediately following the driver's eyes and/or head being oriented at a dangerous viewing location. In creating the driver awareness profile, dangerous viewing locations may be disregarded if detected while the vehicle is stopped or moving at a speed below a predetermined threshold. The driver awareness profile may then be stored in memory 112 or data warehouse 131 of FIG. 1.

Creating a driver awareness profile in step 240 may also include comparing obtained gaze information or driver behavior data with reference data that relates the gaze information or driver behavior data to loss data. The reference data may relate one or more particular behaviors to historic and/or estimated loss data that is associated with the one or more particular behaviors.

Step 240 may also include generating different driver awareness profiles for each driver that operates the vehicle, based on facial recognition results provided by driver sensors 101 in step 200. In particular, step 200 may include a facial recognition process to determine who is driving the vehicle. In step 240, the result of the facial recognition process may be used to determine if the facial recognition results match any of the driver awareness profiles stored in memory 112 or data warehouse 131. If there is a match, the corresponding driver profile may be updated based on the processed gaze information and vehicle information. If the facial recognition results do not match any of the driver awareness profiles, a new driver awareness profile is created that is associated with the facial recognition results.

Alternatively, step 240 may create a single driver awareness profile for all drivers of the vehicle. Step 240 would then update the driver awareness profile with processed gaze and vehicle information regardless of who is driving the vehicle.

Step 240 may also include combining driver awareness profiles from numerous different drivers and different vehicles into an aggregate profile. Viewing locations from different drivers may be combined to determine an average percentage of time during which driver's eyes and head are at dangerous and safe viewing locations, or determine which viewing locations are most commonly associated with accidents or high-risk driving, such as sudden stops or direction changes. Creating a driver awareness profile may include identifying categories of dangerous activities that are associated with certain gaze information. For example, when the driver repeatedly looks down and then back at the road at some predetermined interval, it may be determined that such gaze information indicates that the driver is texting.

In step 250, an insurance risk rating and premium are assigned based on the driver awareness profile. This step may be performed, for example, by analytics servers 132 in FIG. 1. Assigning an insurance risk rating and premium may include analyzing a driver's awareness profile to determine certain risk factors, such as the amount or percentage of time the driver's eyes are pointed at a dangerous viewing location, how often it has been determined that the driver is engaging in dangerous driving activities, such as texting, as well as other risk indicators, and assigning a corresponding risk rating based on these risk factors.

Step 250 may also include comparing a driver's awareness profile to one or more aggregate models stored in data warehouse 131 to assign the insurance risk and premium based on the profile's similarity or dissimilarity from the aggregate model(s). The driver awareness profile may also be compared to other individual driver awareness profiles stored in data warehouse 131, and an insurance risk rating and premium may be assigned based on the profile's relative standing as compared to other profiles.

In step 260, the assigned insurance risk rating and premium may be communicated to the driver or other parties. For example, web server 141 and application server 142 may be used to perform this step. The risk rating and premium may be communicated by making the information available on a website that the user may access through the user's web browser. This information may also be provided via email or text message, for example. Risk rating and premium information may also be communicated through a cell phone or tablet application.

In addition, step 260 may include communicating risk rating and premium information using a display apparatus in the vehicle, or the vehicle's audio system.

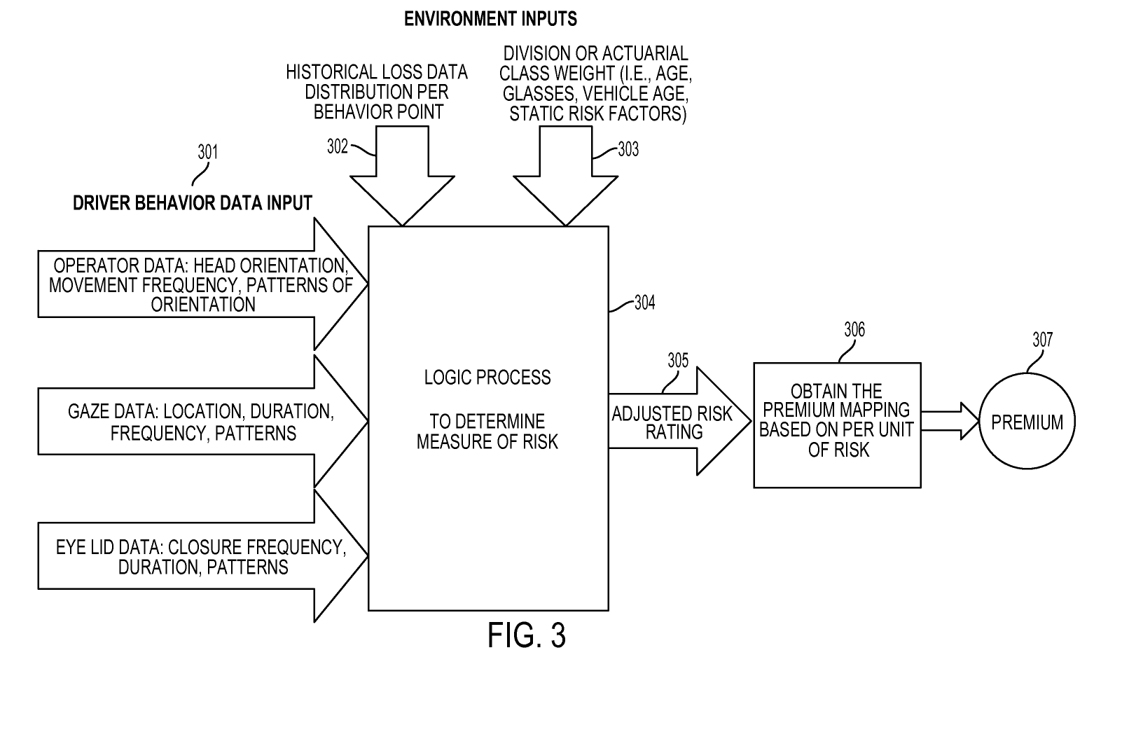

FIG. 3 is a logic diagram illustrating an insurance premium calculation method based on observed driver behavior according to an exemplary embodiment. Referring to FIG. 3, driver behavior data 301 is obtained using driver sensors and/or vehicle sensors. The driver behavior data 301 may include the driver's head orientation, movement frequency, patterns of head orientation, location, duration, frequency, and patterns of the driver's eye orientation, and frequency, duration, and patterns of eye lid closure.

Logic process 304 receives the driver behavior data 301, in addition to historical loss data 302 and division or actuarial class information 303. Historical loss data 302 represents the number of reported insurance claims associated with a particular driver behavior. The historical loss data 302 may also include an estimate of unreported insurance claims associated with the particular behavior. If the number of reported insurance claims associated with a particular driver behavior is not available, the number of claims may be estimated by any loss estimation method that is known in the art.

The division or actuarial class information 303 may include the driver's age, vehicle age, vehicle type, and whether the driver wears glasses. The division or actuarial class information 303 is not limited to these exemplary categories, and may include any other criteria for grouping drivers.

Logic process 304 compares the received driver behavior data 301 to the historical loss data 302 to determine the insurance risk associated with a particular driver. For example, the historical loss data may include loss data that is associated with a specific driver behavior, such as the number of times a driver's eyes are oriented in an unsafe direction (e.g., downward to adjust radio, type text message, etc.). Logic process 304 compares driver behavior data 301 for a specific driver behavior to the historical loss data 302 that corresponds to the specific driver behavior to determine an insurance risk for the driver. Logic process 304 may then adjust the determined insurance risk based on the division or actuarial class information 303 in order to obtain an adjusted risk rating 305 relative to the driver's actuarial class.

Premium mapping 306 is obtained, which correlates adjusted risk rating to a premium that is charged to the customer or insurance policyholder. The premium mapping 306 is used to determine the premium 307 that corresponds to the adjusted risk rating 305.

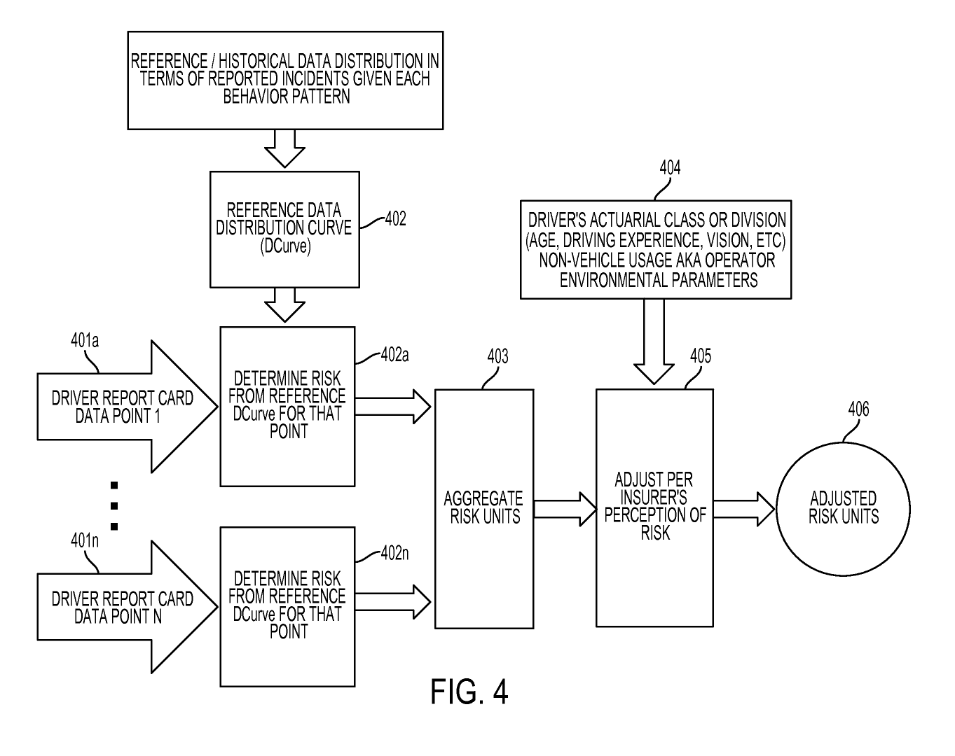

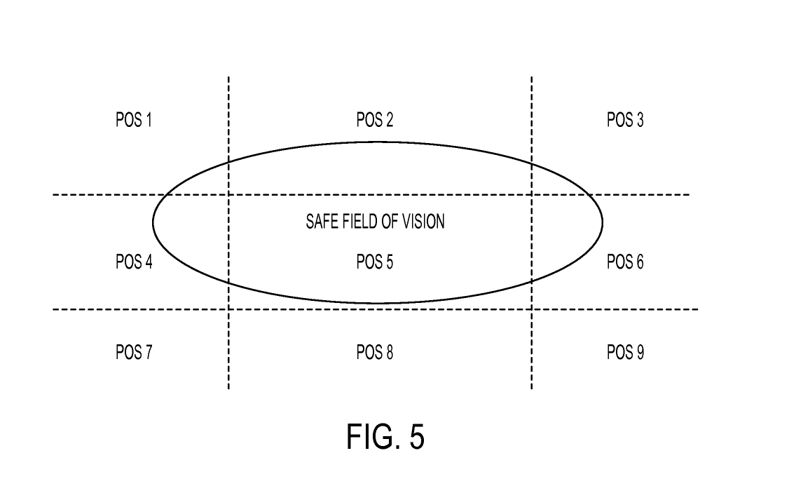

FIG. 4 is an expanded view of logic process 304 shown in FIG. 3. Referring to FIGS. 3 and 4, the driver behavior data 301 may include driver report card data points 401a through 401n. Historical loss data 302 may include one or more reference data distribution curves (D-curves) 402. D-curves 402a through 402n correlate driver report card data points 401a through 401n, respectively, to determine the driver's risk associated with each driver behavior represented in driver report card data points 401a through 401n. The risks associated with each driver report card data point 401a through 401n are combined to determine an aggregate risk rating 403. The aggregate risk rating 403 is adjusted per the insurer's perception of risk at step 405 using the driver's actuarial class or division 404 to obtain an adjusted risk rating 406. An example of determining risk according to an exemplary embodiment is described below in connection with FIGS. 5, 6, 7, and 8A-8D.

FIG. 5 is a representation of a driver's field of vision while operating a vehicle according to an exemplary embodiment. According to an exemplary embodiment, the driver's field of vision is divided into a 3×3 grid that includes 9 positions, although one of skill in the art would understand that the driver's field of vision may be divided in many different ways. Certain portions of the field of vision are determined to be safe. The safe field of vision may be predetermined according to various driving and/or insurance loss statistics, or may be iteratively determined based on the number of insurance claims, vehicle impacts, sudden brakes, swerves, and/or steering overcorrections. As shown in the exemplary embodiment of FIG. 5, portions of positions 1-6 are considered to be in the safe field of vision. Positions 7-9 are not included in the safe field of vision.

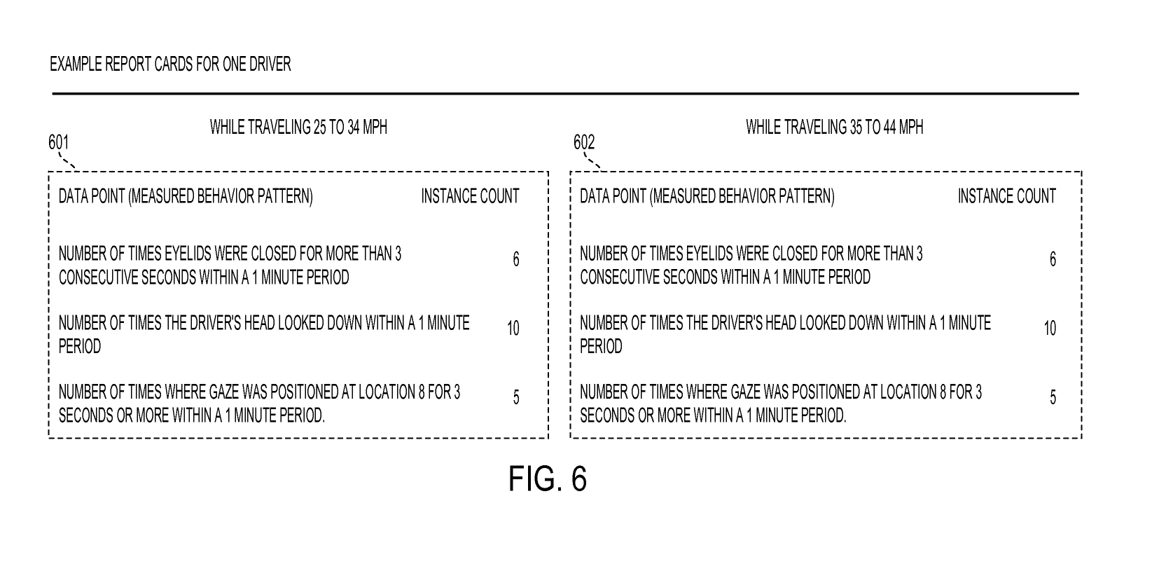

FIG. 6 illustrates a driver report card according to an exemplary embodiment that includes one or more measured driver behaviors. For example, driver report card 601 includes the number of times the driver's eyelids were closed for more than three consecutive seconds within a one-minute period, the number of times the driver's head looked down within a one-minute period, and the number of times the driver's eyes were positioned at position 8 for three seconds or more within a one-minute period. The driver report card 601 may record the number of instances that each behavior occurs while the vehicle is traveling at a particular speed, for example 25 miles per hour (mph) to 34 (mph). Driver report card 602 records the number of instances each of these behaviors occurs while the vehicle is traveling 35 mph to 44 mph. The driver report cards 601 and 602 may include any number of behaviors and may or may not be limited to a particular vehicle speed.

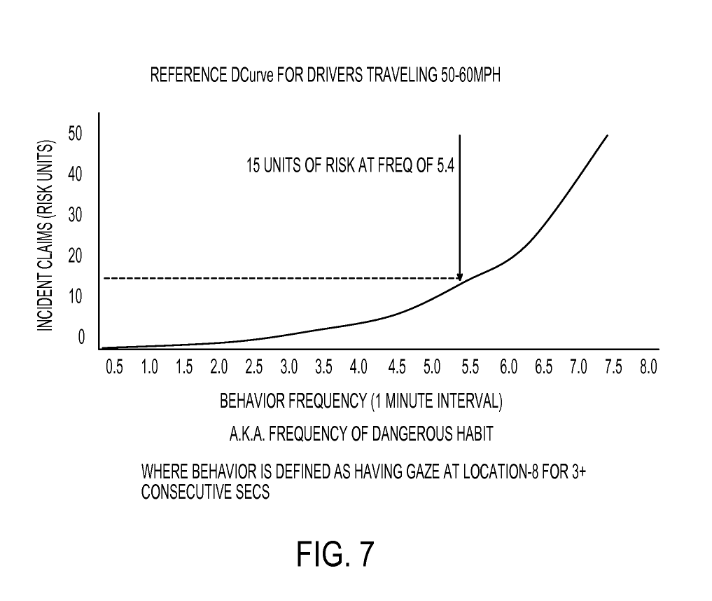

FIG. 7 shows an example of D-curve 402 according to an exemplary embodiment. According to the exemplary embodiment shown in FIG. 7, the number of incident claims is correlated with the frequency of a particular behavior in a one-minute interval. In this example, the behavior is one or more of the driver's eyes being oriented at position 8 (as shown in FIG. 5) for three or more consecutive seconds while the vehicle is traveling between 50 mph and 60 mph. As shown in the D-curve in FIG. 7, the driver's eyes being oriented at position 8 for at least three consecutive seconds 5.4 times in a one minute interval corresponds to 15 incident claims or units of risk. Although the exemplary D-curve in FIG. 7 relates a particular behavior to incident claims while the vehicle is traveling a particular speed, the D-curve may correlate one or more behaviors to incident claims independent of speed. In addition, the incident claims axis may instead be the number of hard brakes, swerving, steering overcorrections, and/or vehicle impacts associated with the driver behavior.

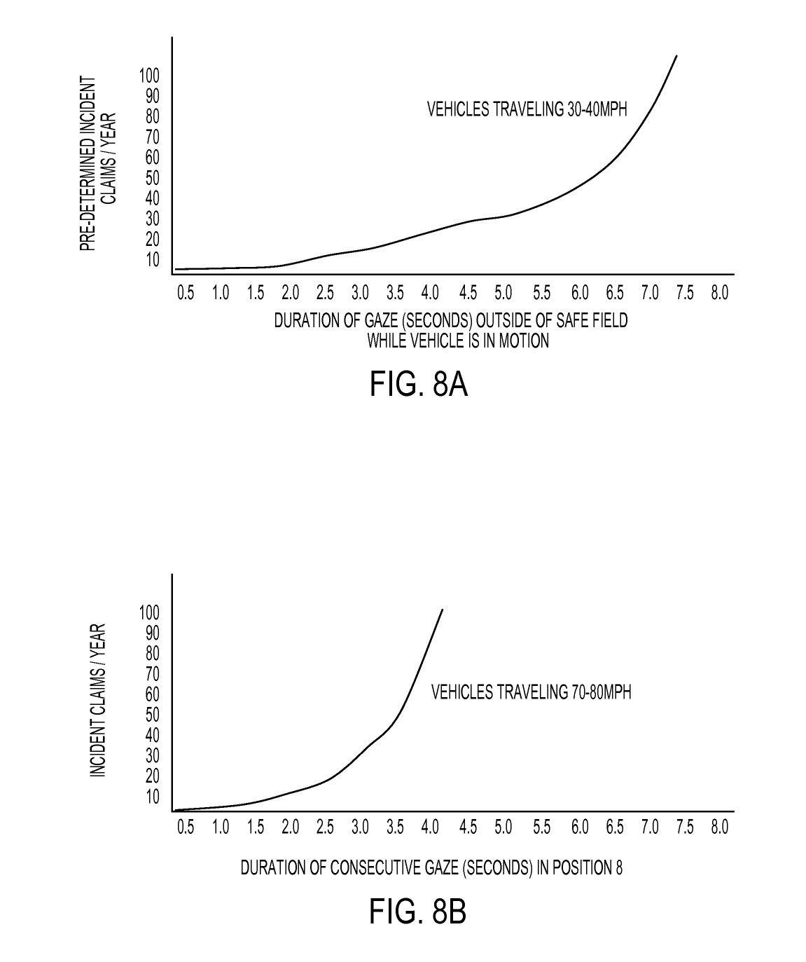

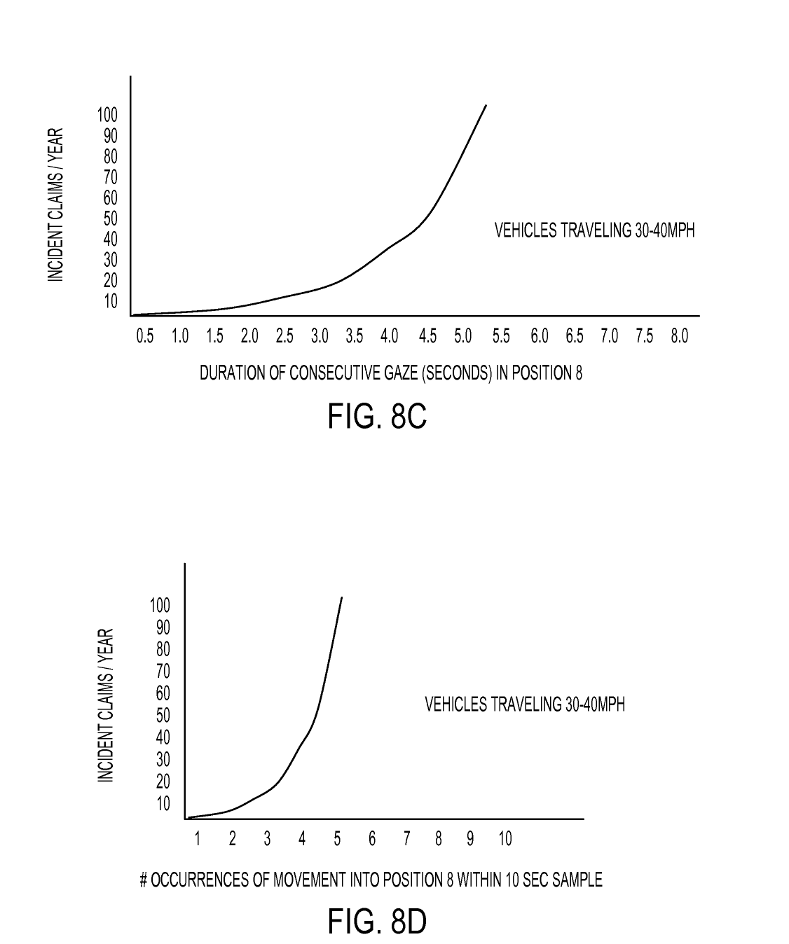

FIGS. 8A-8D illustrate additional exemplary D-curves that relate particular driver behavior to loss data. In FIGS. 8A-8D, the loss data is represented by the number of incident claims per year, however, the loss data may be in a different form, such as the number of hard brakes, swerving, steering overcorrections, and/or vehicle impacts. FIG. 8A illustrates the D-curve associating the duration that the viewer's eyes are oriented outside the safe field of vision (as shown in FIG. 5, for example) while the vehicle is traveling 30 mph to 40 mph, with the number of incident claims per year.

FIG. 8B illustrates a D-curve associating the duration of the driver's eyes oriented in position 8 while traveling 70 mph to 80 mph with the number of incident claims per year. FIG. 8C depicts the same relationship as FIG. 8B, but while the vehicle is traveling between 30 mph and 40 mph. FIG. 8D illustrates a D-curve associating the number of times at least one of the driver's eyes move into position 8 within a 10-second sample (e.g., a driver typing a text message may have a high number of occurrences.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An insurance risk rating system comprising:
a driver sensor that obtains driver behavior data of a driver of a vehicle by monitoring at least one of the driver's head and one or more of the driver's eyes;
a processing unit that compares the driver behavior data with reference data that relates the driver behavior data to loss data; and
a risk rating unit that assigns a risk rating to the driver based on a result of the comparison by the processing unit.

2. The insurance risk rating system of claim 1,
wherein the reference data comprises one or more distributions, each of which relates a driver behavior to at least one of historic and estimated loss data.

3. The insurance risk rating system of claim 2,
wherein the processing unit compares a first driver behavior of the driver behavior data to a first distribution that relates the first driver behavior to at least one of historic and estimated loss data associated with the first driver behavior.

4. The insurance risk rating system of claim 3,
wherein the risk rating unit assigns a risk rating to the driver based on the comparison of the first driver behavior with the first distribution.

5. The insurance risk rating system of claim 4,
wherein the risk rating unit adjusts the risk rating based on an actuarial class of the driver.

6. The insurance risk rating system of claim 2,
wherein the processing unit compares a plurality of driver behaviors of the driver behavior data to a plurality of respective distributions,
wherein each of the respective distributions relate one driver behavior of the plurality of driver behaviors to at least one of historic and estimated loss data associated with said one driver behavior.

7. The insurance risk rating system of claim 6,
wherein the risk rating unit assigns a risk rating to the driver based on the comparison of the plurality of driver behaviors to the plurality of respective distributions.

8. The insurance risk rating system of claim 2,
wherein the historic loss data comprises a number of incident claims reported and/or estimated unreported incident claims associated with the driver behavior.

9. The insurance risk rating system of claim 8,
wherein if historic loss data is not available for the driver behavior, the loss data comprises an estimated number of incident claims associated with the driver behavior.

10. The insurance risk rating system of claim 1, wherein the driver behavior data comprises one or more of the driver's head orientation, head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure.

11. An insurance risk rating method comprising:
obtaining driver behavior data of a driver of a vehicle by monitoring at least one of the driver's head and one or more of the driver's eyes;
comparing the driver behavior data with reference data that relates the driver behavior data to loss data; and
assigning a risk rating to the driver based on a result of the comparing.

12. The insurance risk rating method of claim 11,
wherein the reference data comprises one or more distributions, each of which relates a driver behavior to at least one of historic and estimated loss data.

13. The insurance risk rating method of claim 12,
wherein the comparing comprises comparing a first driver behavior of the driver behavior data to a first distribution that relates the first driver behavior to at least one of historic and estimated loss data associated with the first driver behavior.

14. The insurance risk rating method of claim 13,
wherein the assigning comprises assigning a risk rating to the driver based on the comparison of the first driver behavior with the first distribution.

15. The insurance risk rating method of claim 14, further comprising:
adjusting the risk rating based on an actuarial class of the driver.

16. The insurance risk rating method of claim 12, further comprising:
wherein the comparing comprises comparing a plurality of driver behaviors of the driver behavior data to a plurality of respective distributions,
wherein each of the respective distributions relate one driver behavior of the plurality of driver behaviors to at least one of historic and estimated loss data associated with said one driver behavior.

17. The insurance risk rating method of claim 16,
wherein the assigning comprises assigning a risk rating to the driver based on the comparison of the plurality of driver behaviors to the plurality of respective distributions.

18. The insurance risk rating method of claim 12,
wherein the historic loss data comprises a number of incident claims reported and/or estimated unreported incident claims associated with the driver behavior.

19. The insurance risk rating method of claim 18,
wherein if historic loss data is not available for the driver behavior, the loss data comprises an estimated number of incident claims associated with the driver behavior.

20. The insurance risk rating method of claim 11, wherein the driver behavior data comprises one or more of the driver's head orientation, head movement frequency, one or more patterns of changing head orientation, gaze location of at least one of the driver's eyes, a duration of the driver's gaze location, one or more patterns of changing gaze location, frequency at which the driver's gaze location changes, frequency at which the driver's gaze location corresponds to a predetermined dangerous location, frequency at which one or more of the driver's eyes close, a duration of eye closure, and one or more patterns of eye closure.
